(19) United States
(12) Patent Application Publication
(10) Pub. No.: US 2022/0327046 A1
(43) Pub. Date: Oct. 13, 2022

(54) TESTING SYSTEM, TESTING METHOD, AND TESTING PROGRAM

(71) Applicant: NIPPON TELEGRAPH AND TELEPHONE CORPORATION, Tokyo (JP)

(72) Inventors: Go YAMAMOTO, Musashino-shi, Tokyo (JP); Tetsuya KUSUMOTO, Musashino-shi, Tokyo (JP)

(73) Assignee: NIPPON TELEGRAPH AND TELEPHONE CORPORATION, Tokyo (JP)

(21) Appl. No.: 17/627,125

(22) PCT Filed: Jul. 19, 2019
(86) PCT No.: PCT/JP2019/028534

§ 371 Date: Jan. 14, 2022

(51) Int. Cl. G06F 11/36; G06F 21/60; G06F 21/78

(52) U.S. Cl. CPC G06F 11/3688; G06F 11/3684; G06F 11/3692; G06F 21/602; G06F 21/78

(57) ABSTRACT

A test system includes an information processing apparatus configured to receive input of software to be developed using an ID-based cipher, and a simulation apparatus configured to test the software. The simulation apparatus includes processing circuitry configured to store confidential information, generate a private key for an ID using the confidential information stored in the storage, encrypt, when an encryption request including plaintext and the ID is received, the plaintext using a private key corresponding to the ID, decrypt, when a decryption request including ciphertext and the private key is received, the ciphertext using the private key, and output a processing result of an encryption process performed and a decryption process performed as a test result.

### TECHNICAL FIELD

The present invention relates to a test system, a test method, and a test program.

### BACKGROUND ART

In system development such as web system development, there is a method in the related art of repeating a test step many times for quality control and quality enhancement of software. With regard to this, automation of some or all of the test step is known (for example, see Non Patent Literature 1).

In addition, the development of software using cryptography includes processes of distributing and managing private keys for encryption. The processes of distribution and management of such a key include a step that requires verification by a user.

### CITATION LIST

### Non Patent Literature

Non Patent Literature 1: “Selenium Documentation”, Introduction Test Automation for Web Applications [online], [Retrieved on Jul. 9, 2019], Internet <https://www.seleniumhq.org/docs/01_introducing_selenium.jsp#test-automation-for-web-applications>

### SUMMARY OF THE INVENTION

### Technical Problem

However, the development of software using cryptography of the related art has problems that the test step cannot be automated and the development may not be efficiently performed. That is, in the development of software using cryptography of the related art, automation of tests is difficult because the verification step is included in the key distribution and management step.

For example, in a system using ID-based ciphers, there is a key issuing center and a private key is distributed to each entity according to the ID of the entity. At that time, the key issuing center verifies whether the entity legitimately retains its ID.

Here, processes for verifying the legitimacy of the ID significantly vary depending on the physical properties of the entity and the type and function of a product. Therefore, it is difficult to uniformly automate the process for verifying the legitimacy of an ID. In addition, in the system using ID-based ciphers, the automation of the test step is difficult because an entity needs to receive the distribution of a private key from the key issuing center. Thus, the system development using such cryptography has the problem that it is difficult to increase efficiency of testing to a certain degree or more.

### Means for Solving the Problem

In order to solve the above-described problem and achieve the objective, a test system of the present invention includes an information processing apparatus configured to receive input of software to be developed using an ID-based cipher, and a simulation apparatus configured to test the software, in which the simulation apparatus includes a storage unit configured to store confidential information, a key generation unit configured to generate a private key for an ID using the confidential information stored in the storage unit, an encryption unit configured to encrypt, when an encryption request including plaintext and an ID is received, the plaintext using a private key corresponding to the ID, a decryption unit configured to decrypt, when a decryption request including ciphertext and the private key is received, the ciphertext using the private key, and an output unit configured to output a processing result of an encryption process performed by the encryption unit and a decryption process performed by the decryption unit as a test result.

### Effects of the Invention

According to the present invention, the effect of efficiently performing development in software development using cryptography can be exhibited.

### BRIEF DESCRIPTION OF DRAWINGS

FIG. 1 is a diagram illustrating an example of a configuration of a test system according to a first embodiment.

FIG. 2 is a diagram describing a key generation process by a key generation unit.

FIG. 3 is a diagram describing an encryption process by an encryption unit.

FIG. 4 is a diagram describing a decryption process by a decryption unit.

FIG. 5 is a flowchart showing an example of a process performed by a simulation apparatus according to the first embodiment.

FIG. 6 is a diagram illustrating an example of a configuration of a test system according to a second embodiment.

FIG. 7 is a diagram for describing an overview of a test process of the test system according to the second embodiment.

FIG. 8 is a diagram illustrating an example of a configuration of a test system according to a third embodiment.

FIG. 9 is a diagram for describing an overview of a test process of the test system according to the third embodiment.

FIG. 10 is a diagram illustrating a computer that executes a test program.

### DESCRIPTION OF EMBODIMENTS

Hereinafter, embodiments of a test system, a test method, and a test program according to the present application will be described in detail with reference to the accompanying drawings. Further, the test system, the test method, and the test program according to the present application are not limited to these embodiments.

### First Embodiment

In the following embodiment, a configuration of a test system 100 according to a first embodiment and a process of a simulation apparatus 10 will be described in order, and effects of the first embodiment will be described last.

Configuration of Test System

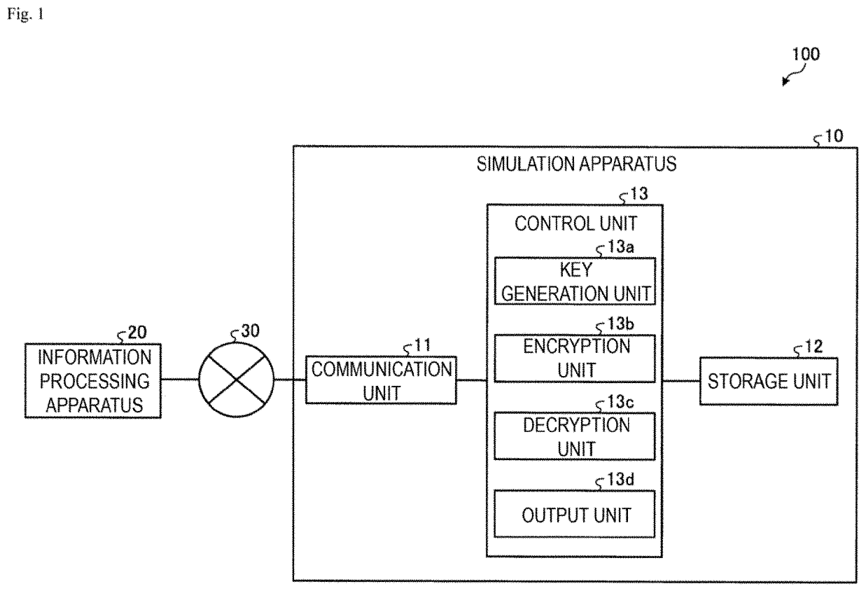

First, a configuration of the test system 100 will be described using FIG. 1. FIG. 1 is a diagram illustrating an example of a configuration of the test system according to the first embodiment.

The test system 100 includes the simulation apparatus 10 and an information processing apparatus 20 as illustrated in FIG. 1. In addition, the simulation apparatus 10 and the information processing apparatus 20 are connected to each other via a network 30.

The simulation apparatus 10 simulates software to be developed using cryptography for ID-based ciphers received by the information processing apparatus 20 in a simulation environment in which a target system is simulated. Here, when the software to be developed is to be simulated, the simulation apparatus 10 acquires a function stored in the information processing apparatus 20. Here, the function indicates a block of program code sets that function independently. Further, the specific scheme for ID-based ciphers may be any scheme, and for example, the Boneh Franklin scheme may be applied.

Then, the simulation apparatus 10 performs a simulation of an encryption process and a decryption process using the ID-based ciphers and outputs the processing results of the encryption process and the decryption process to the information processing apparatus 20 as test results. For example, the simulation apparatus 10 tests whether the correct output can result from the correct input in the encryption process and the decryption process. In addition, for example, the simulation apparatus 10 tests whether an error can be output appropriately for an incorrect input in the encryption process and the decryption process.

The information processing apparatus 20 receives the input of the software to be developed using the ID-based ciphers. For example, the information processing apparatus 20 receives the source code of a program of the software related to the ID-based ciphers created by a developer and transmits the code as data to be tested to the simulation apparatus 10. In addition, the information processing apparatus 20 receives the test results from the simulation apparatus 10 and displays the test results. For example, as the test results, the information processing apparatus 20 displays the presence/absence of a defect, the details of the defect, and the like in the encryption process and the decryption process for the ID-based ciphers of the software to be developed.

The simulation apparatus 10 includes a communication unit 11, a storage unit 12, and a control unit 13. Hereinafter, processing operations of the respective units included in the simulation apparatus 10 will be described.

The communication unit 11 is a communication interface that transmits and/or receives various types of information to and/or from another apparatus connected via a network or the like. The communication unit 11 is implemented by a network interface card (NIC) or the like and performs communication with another apparatus via an electrical communication line such as a local area network (LAN) or the Internet. For example, the communication unit 11 receives the source code to be tested from the information processing apparatus 20. In addition, the communication unit 11 transmits the test results of the encryption process and the decryption process for the ID-based ciphers to the information processing apparatus 20.

In addition, the storage unit 12 stores data and programs required for various processing operations performed by the control unit 13. For example, the storage unit 12 is a semiconductor memory element such as a random access memory (RAM) or a flash memory, a storage device such as a hard disk or an optical disc, or the like. The storage unit 12 stores various kinds of data necessary for processing the ID-based ciphers. For example, the storage unit 12 stores predetermined confidential information X. This confidential information X is read when a key generation unit 12a, which will be described below, generates a private key.

The control unit 13 has an internal memory for storing programs and required data in which various processing procedures and the like are defined and executes various processing operations with the programs and the data. For example, the control unit 13 is an electronic circuit such as a central processing unit (CPU) or a micro processing unit (MPU), or an integrated circuit such as an application specific integrated circuit (ASIC) or a field programmable gate array (FPGA). In addition, the control unit 13 includes the key generation unit 13a, an encryption unit 13b, a decryption unit 13c, and an output unit 13d.

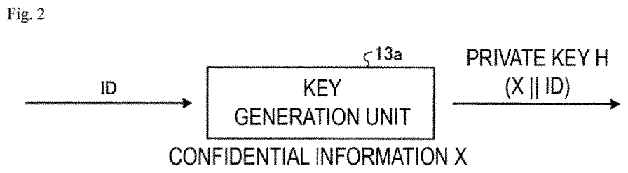

The key generation unit 13a generates a private key for each ID using the confidential information stored in the storage unit 12. Here, a key generation process by the key generation unit 13a will be described using FIG. 2. FIG. 2 is a diagram describing the key generation process by the key generation unit. When the key generation unit 13a receives input of an ID, the key generation unit 13a reads the confidential information X from the storage unit 12 and generates a private key H(X ∥ ID) using a private key as illustrated in FIG. 2, for example. Here, H is a hash function.

When an encryption request including plaintext and the ID is received, the encryption unit 13b encrypts the plaintext using the private key corresponding to the ID. In the encryption of ID-based ciphers, for example, the encryption unit 13b performs the encryption using the function (X ∥ ID) as a private key using common key block cryptography such as the Advanced Encryption Standard (AES).

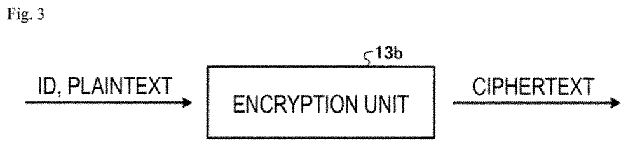

The encryption process performed by the encryption unit 13b will be described here using FIG. 3. FIG. 3 is a diagram describing the encryption process performed by the encryption unit. When input of plaintext and an ID is received, for example, the encryption unit 13b encrypts the plaintext using a private key corresponding to the ID and outputs ciphertext as illustrated in FIG. 3.

When a decryption request including the ciphertext and the private key is received, the decryption unit 3c decrypts the ciphertext using the private key. In the decryption, for example, the decryption unit 13c performs decryption using the function (X ∥ ID) as a private key.

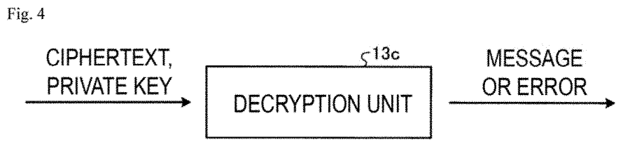

The decryption process performed by the decryption unit 13c will be described here using FIG. 4. FIG. 4 is a diagram describing the decryption process performed by the decryption unit. When the decryption unit 13c receives the ciphertext and the private key, for example, the decryption unit decrypts the ciphertext using the private key and outputs a decrypted message if the decryption is successful, as illustrated in FIG. 4. In addition, if the decryption fails because the private key is wrong or the ciphertext has been tampered with, the decryption unit 13c outputs an error.

Here, if the decryption unit 13c does not output an error even though a wrong private key or ciphertext that has been tampered with has been input, for example, the software to be developed with ID-based ciphers is defective. In addition, even if the decryption unit 13c outputs an error, for example, even though a legitimate private key and ciphertext have been input, the software to be developed with ID-based ciphers is defective.

The output unit 13d outputs processing results of the encryption process performed by the encryption unit 13b and the decryption process performed by the decryption unit 13c as test results. For example, the output unit 13d outputs the presence/absence of a defect, the details of the defect, and the like in the encryption process and the decryption process for the ID-based ciphers of the software to be developed as the test results.

In this way, the simulation apparatus 10 can realize a simulator with the ID-based ciphers (further, refer to the random oracle model disclosed in References 1 and 2 below for proof that this configuration has no problems).
Reference 1: Mihir Bellare, Phillip Rogaway, “Random Oracles are Practical: A Paradigm for Designing Efficient Protocols”, First ACM Conference on Computer and Communications Security, 62-73, 1993, ACM Press
Reference 2: Wikipedia (Jun. 13, 2019) Random oracle <https://en.wikipedia.org/wiki/Random_oracle>

Processing Procedure of Simulation Apparatus

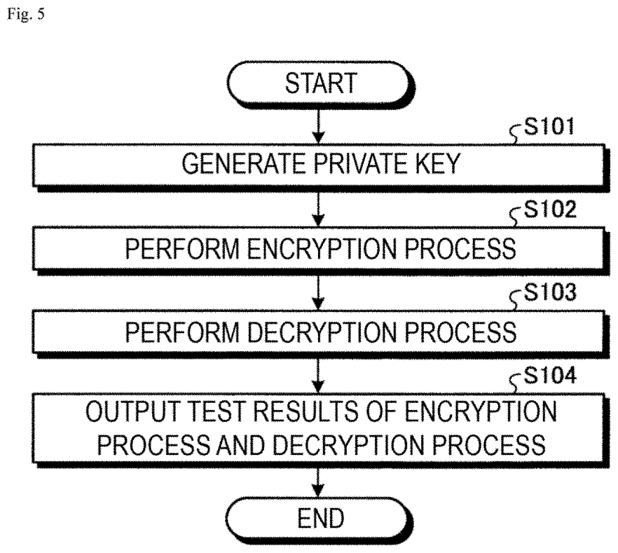

Next, an example of a processing procedure performed by the simulation apparatus 10 according to the first embodiment will be described using FIG. 5. FIG. 5 is a flowchart showing an example of a process performed by the simulation apparatus according to the first embodiment. Further, it is assumed in the example of FIG. 5 that the private key generation process, the encryption process, the decryption process, and the test result output process are automatically performed as a series of test steps.

The key generation unit 13a of the simulation apparatus 10 generates a private key (step S101) as illustrated in FIG. 5. Specifically, the key generation unit 13a generates a private key for each ID using confidential information stored in the storage unit 12. For example, when input of an ID is received, the key generation unit 13a reads the confidential information X from the storage unit 12 and generates a private key H(X ∥ ID) using another private key.

Then, the encryption unit 13b receives an encryption request including plaintext and the ID and encrypts the plaintext using the private key corresponding to the ID (step S102).

Subsequently, the decryption unit 13c receives a decryption request including ciphertext and the private key and decrypts the ciphertext using the private key (step S103).

Then, the output unit 13d outputs the test results of the encryption process performed by the encryption unit 13b and the decryption process performed by the decryption unit 13c (step S104). For example, the output unit 13d outputs the presence/absence of a defect, the details of the defect, and the like in the encryption process and the decryption process for the ID-based ciphers of the software to be developed as the test results.

Effects of First Embodiment

As described above, the simulation apparatus 10 of the test system 100 according to the first embodiment generates a private key for each ID using the confidential information stored in the storage unit 12. Then, when an encryption request including plaintext and an ID is received, the simulation apparatus 10 encrypts the plaintext using the private key corresponding to the ID. In addition, when a decryption request including the ciphertext and the private key is received, the simulation apparatus 10 decrypts the ciphertext using the private key. Then, the simulation apparatus 10 outputs the processing results of the encryption process and the decryption process as test results. Thus, in development of software using cryptography, the test system 100 enables the development to be efficient.

In other words, instead of an external key issuing center that issues a private key, the simulation apparatus 10 of the test system 100 generates a private key and uses the private key to realize a simulator with ID-based ciphers, and thus the test step can be automated in the development of the software using cryptography, which enables the development to be efficient, without communicating with such an external key issuing center.

This enables, for example, the test system 100 to automatically perform tests by simulating the portion of the ID-based ciphers first in developing a system using the ID-based ciphers, and if the system is completed, the originally desired system may be completed by replacing the simulator with the implementation of the originally desired ID-based ciphers.

### Second Embodiment

Although the case in which the software using ID-based ciphers is executed by the simulation apparatus 10 has been described in the first embodiment above, the present invention is not limited to this embodiment, and for example, it is possible to select either the simulation apparatus 10 or a tested system 40 as a target system to execute the software using ID-based ciphers.

As a second embodiment, a case in which an information processing apparatus 20A determines whether software to be developed is to be executed by the simulation apparatus 10 or by the tested system 40 according to attribute information preset in a code of the software and then causes the software to be executed by the simulation apparatus or by the tested system 40 according to the determination result will be described. Further, description of configurations and processes similar to those of the first embodiment will be omitted as appropriate.

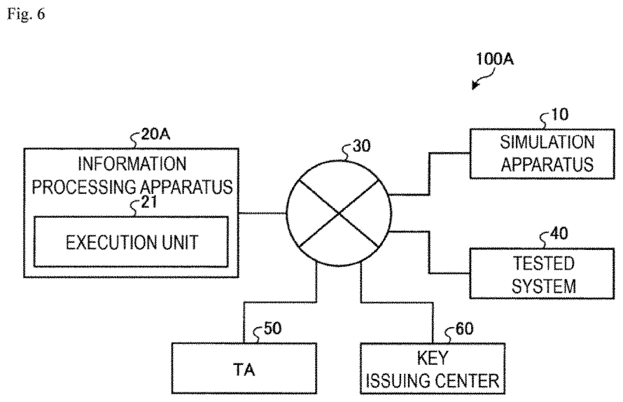

FIG. 6 is a diagram illustrating an example of a configuration of a test system according to the second embodiment. A test system 100A includes the simulation apparatus 10, the information processing apparatus 20A, the tested system 40, a trusted authority (TA) 50, and a key issuing center 60 as illustrated in FIG. 6. In addition, the apparatuses are connected to one another via a network 30.

The tested system 40 is an actual system to which software using ID-based ciphers being developed is applied. The IA 50 receives a request to issue a private key with an ID from the tested system, verifies whether the ID is legitimate, and notifies the key issuing center 60 of the request to issue a private key with the ID if the ID is legitimate. When the request to issue a private key is received, the key issuing center 60 issues a private key using the ID and distributes the private key to the tested system 40 via the TA.

The information processing apparatus 20A includes an execution unit 21. The execution unit 21 determines whether software to be developed is to be executed by the simulation apparatus 10 or by the tested system 40 according to attribute information preset in a code of the software. Then, the execution unit 21 causes the software to be executed by the simulation apparatus 10 or the tested system 40 according to the determination result.

For example, the information processing apparatus 20A receives the software with ID-based ciphers to which a developer has given an attribute value of the compiler option in the code. Due to the compiler option being given, the indication of whether the software is to be executed by the simulation apparatus 10 or by the tested system 40 can be given to the compiler during compilation.

In other words, the execution unit 21 refers to the attribute value of the compiler option during compilation, determines whether the software is to be executed by the simulation apparatus 10 or by the tested system 40, and causes the software to be executed by the simulation apparatus 10 or by the tested system 40 according to the determination result.

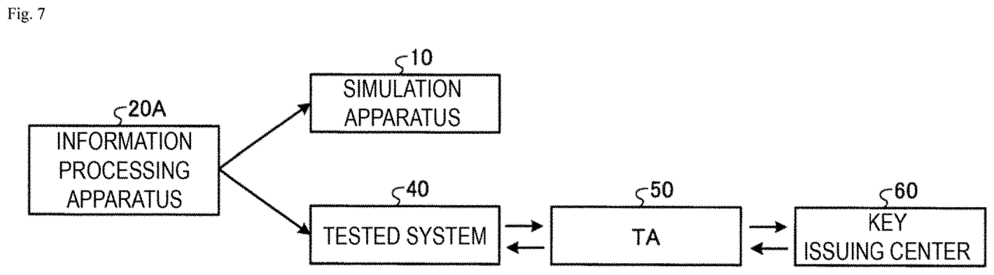

Here, an overview of a test process performed by the test system 100A according to the second embodiment will be described using FIG. 7. FIG. 7 is a diagram for describing an overview of the test process of the test system according to the second embodiment. The information processing apparatus 20A causes the software to be executed by the simulation apparatus 10 as illustrated in FIG. 7 if an attribute value indicating that the software is to be executed by the simulation apparatus 10 is given to a code in the compiler option. Then, the simulation apparatus 10 performs a test as the simulation apparatus 10 simulates the software with the ID-based ciphers as described in the first embodiment.

On the other hand, the information processing apparatus 20A causes the software to be executed by the tested system 40 if an attribute value indicating that the software is to be executed by the tested system 40 is given to a code in the compiler option. The tested system 40 executes the software of the ID-based ciphers and transmits a request to issue a private key to the TA 50.

The TA 50 receives the request to issue a private key with the ID from the tested system, verifies whether the ID is legitimate, and notifies the key issuing center 60 of the request to issue a private key with the ID if the ID is legitimate. When the request to issue a private key is received, the key issuing center 60 issues a private key using the ID and distributes the private key to the tested system 40 via the TA.

As described above, with the test system 100A according to the second embodiment, a developer can select whether a simple test can be performed by the simulation apparatus 10 specializing only in ID-based ciphers or whether a full-scale test can be performed to verify that the software can be implemented in the tested system 40 only by changing the attribute information of the source code of the software that handles development.

### Third Embodiment

Although the case in which a developer selects a system that executes the software to be developed has been described in the second embodiment above, the present invention is not limited to the second embodiment and a system that executes the software may be dynamically switched.

Hereinafter, a case in which, when software to be developed is executed by the tested system 40 and an abnormality occurs in the software, an information processing apparatus 203 causes the software to be executed by the simulation apparatus 10 and acquires test results from the simulation apparatus will be described as a third embodiment. Further, description of configurations and processes similar to those of the first and second embodiments will be omitted as appropriate.

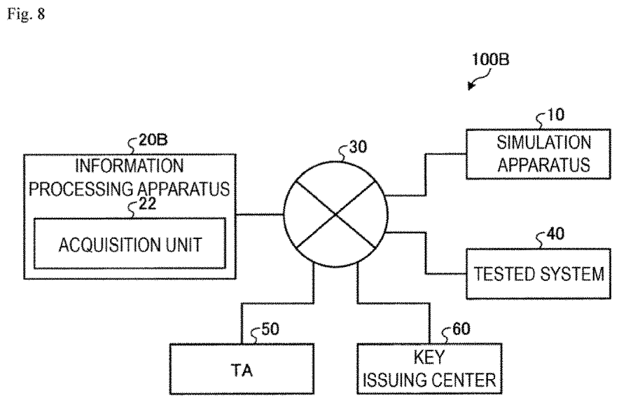

FIG. 8 is a diagram illustrating an example of a configuration of a test system according to the third embodiment. The information processing apparatus 20B of a test system 100B according to the third embodiment includes an acquisition unit 22 as illustrated in FIG. 8. When software to be developed is executed by the tested system 40 and an abnormality occurs in the software, the acquisition unit 22 of the information processing apparatus 20B causes the software to be executed by the simulation apparatus 10 and acquires test results from the simulation apparatus 10.

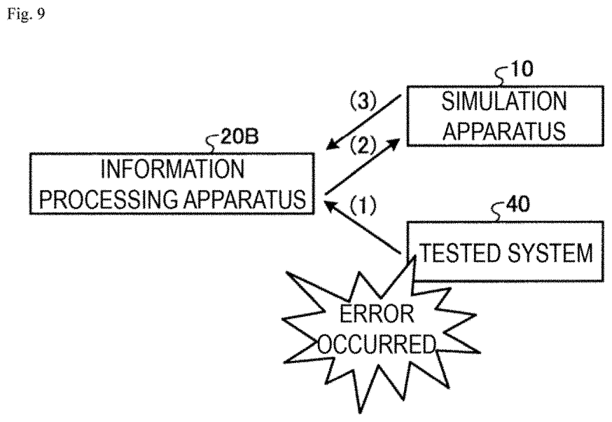

Here, an overview of a test process performed by the test system 100B according to the third embodiment will be described using FIG. 9. FIG. 9 is a diagram for describing an overview of a test process of the test system according to the third embodiment. When the tested system 40 executes the software to be developed and an error occurs, the tested system 40 reports the error to the information processing apparatus 20B as illustrated in FIG. 9 (see (1) of FIG. 9). Then, when the report on the error is received from the tested system 40, the information processing apparatus 20B causes the simulation apparatus 10 to perform tests on the software to be developed (see (2) of FIG. 9). Thereafter, the simulation apparatus 10 notifies the information processing apparatus 20B of the report on the test results (see (3) of FIG. 9).

In this way, the information processing apparatus 208 of the test system 100B according to the third embodiment can acquire the report on the error from the tested system 40 and the report on the test results from the simulation apparatus 10 and thus can facilitate identification of the cause of the error in the software to be tested. For example, even when it is not possible to identify the cause of an abnormality of the software only with a report on the error from the tested system 40, the test system 100B may identify the defect in processing of ID-based ciphers or identify that there is no defect in processing of ID-based ciphers by performing tests in the simulation apparatus 10.

System Configuration, Etc.

In addition, components of the apparatuses illustrated in the drawings are functionally conceptual and are not necessarily physically configured as illustrated in the drawings. That is, the specific aspects of distribution and integration of the apparatuses are not limited to those illustrated in the drawings, and all or some of the components may be distributed or integrated functionally or physically in desired units depending on various kinds of loads, states of use, and the like. Further, all or some of the processing functions performed by the apparatuses can be implemented by a CPU and a program analyzed and executed by the CPU or implemented as hardware with wired logic.

In addition, all or some of the processing operations described as being automatically performed among the processing operations described in the present embodiment may be performed manually, or all or some of the processing operations described as being manually performed may be performed automatically using a known method. Furthermore, processing procedures, control procedures, specific names, and the information including various types of data and parameters described in the above-described documents and drawings can be arbitrarily changed unless otherwise mentioned.

Program

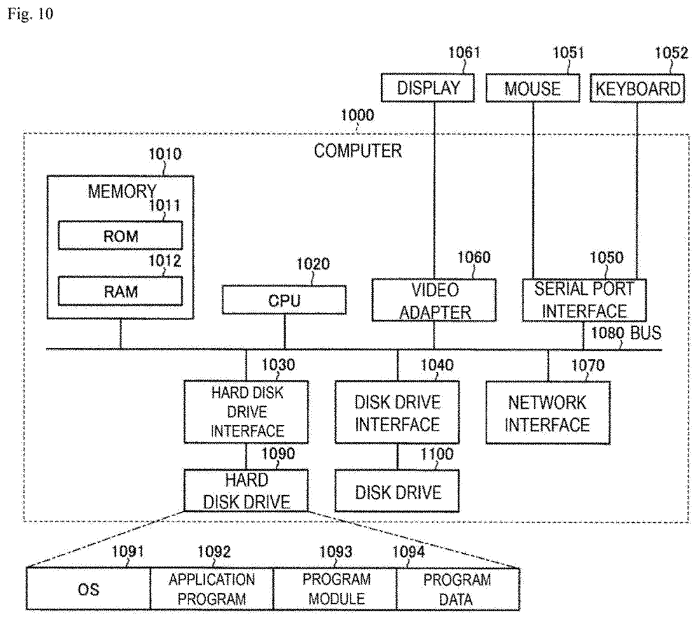

FIG. 10 is a diagram illustrating a computer that executes a test program. A computer 1000 includes, for example, a memory 1010 and a CPU 1020. In addition, the computer 1000 includes a hard disk drive interface 1030, a disk drive interface 1040, a serial port interface 1050, a video adapter 1060, and a network interface 1070. These units are connected to one another by a bus 1080.

The memory 1010 includes a read only memory (ROM) 1011 and a RAM 1012. The ROM 1011 stores a boot program, for example, a basic input/output system (BIOS), or the like. The hard disk drive interface 1030 is connected to a hard disk drive 1090. The disk drive interface 1040 is connected to a disk drive 1100. A removable storage medium, for example, a magnetic disk, an optical disc, or the like is inserted into the disk drive 1100. The serial port interface 1050 is connected to, for example, a mouse 1051 and a keyboard 1052. The video adapter 1060 is connected to, for example, a display 1061.

The hard disk drive 1090 stores, for example, an OS 1091, an application program 1092, a program module 1093, and program data 1094. In other words, a program defining each process performed by the simulation apparatus 10 is mounted as the program module 1093 in which computer executable codes are described. The program module 1093 is stored in, for example, the hard disk drive 1090. For example, the program module 1093 for executing the same process as that performed by the functional configuration in the apparatus is stored in the hard disk drive 1090. Further, the hard disk drive 1090 may be replaced with a solid state drive (SSD).

In addition, data used for the processes of the above-described embodiment is stored in, for example, the memory 1010 or the hard disk drive 1090 as the program data 1094. In addition, the CPU 1020 reads and executes the program module 1093 or the program data 1094 stored in the memory 1010 or the hard disk drive 1090 in the RAM 1012 as necessary.

Further, the program module 1093 and the program data 1094 are not necessarily stored in the hard disk drive 1090, may be stored in, for example, a removable storage medium, and be read by the CPU 1020 through the disk drive 1100 or the like. Alternatively, the program module 1093 and the program data 1094 may be stored in another computer connected through a network or a wide area network (WAN). In addition, the program module 1093 and the program data 1094 may be read by the CPU 1020 from another computer through the network interface 1070.

### REFERENCE SIGNS LIST

10 Simulation apparatus
11 Communication unit
12 Storage unit
13 Control unit
13a Key generation unit
13b Encryption unit
13c Decryption unit
13d Output unit
20 Information processing apparatus
21 Execution unit
22 Acquisition unit
30 Network
40 rested system
50 TA
60 Key issuing center

1. A test system comprising:
an information processing apparatus configured to receive input of software to be developed using an ID-based cipher; and
a simulation apparatus configured to test the software,
wherein the simulation apparatus includes:
processing circuitry configured to:
store confidential information,
generate a private key for an ID using the confidential information stored in the storage,
encrypt, when an encryption request including plaintext and the ID is received, the plaintext using a private key corresponding to the ID,
decrypt, when a decryption request including ciphertext and the private key is received, the ciphertext using the private key, and
output a processing result of an encryption process performed and a decryption process performed as a test result.

2. The test system according to claim 1, further including:
a tested system to which the ID-based cipher is applied,
wherein the information processing apparatus includes processing circuitry configured to determine whether the software is to be executed by the simulation apparatus or the software is to be executed by the tested system according to attribute information preset in a code of the software and to cause the software to be executed by the simulation apparatus or the tested system based on a determination result.

3. The test system according to claim 1, further including:
a tested system to which the ID-based cipher is applied,
wherein the information processing apparatus includes processing circuitry configured to, when the software is executed by a tested system and an abnormality occurs in the software, cause the software to be executed by the simulation apparatus and acquire a test result from the simulation apparatus.

4. A test method executed by a simulation apparatus configured to test software to be developed using an ID-based cipher, the test method comprising:
generating a private key for an ID using predetermined confidential information stored in a storage;
encrypting, when an encryption request including plaintext and an ID is received, the plaintext using a private key corresponding to the ID;
decrypting, when a decryption request including ciphertext and the private key is received, the ciphertext using the private key; and
outputting a processing result of an encryption process performed in the encrypting and a decryption process performed in the decrypting as a test result.

5. A non-transitory computer-readable recording medium storing therein a test program that causes a computer to execute a process comprising:
generating a private key for an ID using predetermined confidential information stored in a storage;
encrypting, when an encryption request including plaintext and an ID is received, the plaintext using a private key corresponding to the ID;
decrypting, when a decryption request including ciphertext and the private key is received, the ciphertext using the private key; and
outputting a processing result of an encryption process performed and a decryption process performed as a test result.
